(19) United States
(12) Patent Application Publication
(10) Pub. No.: US 2025/0259051 A1
(43) Pub. Date: Aug. 14, 2025

(54) MACHINE LEARNING LIBRARIES FOR RECIPE SETUP

(71) Applicant: KLA Corporation, Milpitas, CA (US)

(72) Inventors: Stilian Pandev, Santa Clara, CA (US); Min-Yeong Moon, Ann Arbor, MI (US); Pavan Gurudath, Ann Arbor, MI (US)

(21) Appl. No.: 18/438,136

(22) Filed: Feb. 9, 2024

(51) Int. Cl. G06N 3/08; G06T 7/00

(52) U.S. Cl. CPC G06N 3/08; G06T 7/001; G06T 2207/10061; G06T 2207/20081; G06T 2207/20084; G06T 2207/30148

(57) ABSTRACT

Methods and systems for constructing a machine learning (ML) library are provided. One method includes defining multiple architecture blocks, each of which is a reusable piece of ML architecture, and defining multiple architecture templates, each of which is a reusable template configurable for including one or more of the multiple architecture blocks. The method also includes assigning metadata to the templates responsive to input data metrics and performance objectives for which the templates are suited. The method further includes storing the blocks, templates, and metadata in a ML library configured for use in selecting one or more of the templates for an application-specific ML architecture based on the input data metrics and the performance objectives specific to the application. Similar steps may be performed for loss functions and hyperparameters. The embodiments provide flexibility and extendibility of ML architectures for application-specific challenging scenarios for applications such as metrology.

### BACKGROUND OF THE INVENTION

### 1. Field of the Invention

The present invention generally relates to methods and systems for constructing a machine learning (ML) library. Certain embodiments relate to using the ML library to create an application-specific ML architecture for use in a process such as wafer inspection or metrology. The embodiments described herein can advantageously be used to improve the flexibility and extendibility of ML architectures to thereby enable application-specific architecture in various application-specific challenging scenarios for metrology solutions.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

One difficulty associated with processes such as those described above is generating a suitable recipe that can be used to successfully determine the information that the user cares about. Sometimes, one or a few ML architectures are used for developing a metrology recipe. Typically, in such recipe setup, the training algorithms, loss function, data preprocessing, etc. is fixed and does not depend on the data available and the performance objectives (e.g., robustness, tool matching, precision, etc.).

Currently used recipe setup has, therefore, a number of important disadvantages. For example, the same architecture may be used for all applications. In other words, the currently used methods may not utilize the application specific characteristics of different ML architectures. In addition, the currently used methods may only use one of the very few architectures available. The currently used methods may also use hardcoded architectures, meaning that there are no capabilities of modifying existing or adding new architectures. Furthermore, the currently used methods may use only a predetermined loss function and predetermined hyperparameters.

Accordingly, it would be advantageous to develop systems and methods for constructing a ML library that can be used for recipe setup that do not have one or more of the disadvantages described above.

### SUMMARY OF THE INVENTION

The following description of various embodiments is not to be construed in any way as limiting the subject matter of the appended claims.

One embodiment relates to a system configured for constructing a machine learning (ML) library. The system includes one or more computer systems configured for defining multiple architecture blocks, each of which is a reusable piece of ML architecture. The computer system(s) are also configured for defining multiple architecture templates, each of which is a reusable template configurable for including one or more of the multiple architecture blocks. In addition, the computer system(s) are configured for assigning metadata to the multiple architecture templates responsive to input data metrics and performance objectives for which the multiple architecture templates are suited. The computer system(s) are further configured for storing the multiple architecture blocks, the multiple architecture templates, and the metadata in a ML library configured for use in selecting one or more of the multiple architecture templates for an application-specific ML architecture (ASMLA) based on the input data metrics and the performance objectives specific to the application. The system may be further configured as described herein.

Another embodiment relates to a computer-implemented method for constructing a ML library. The method includes the steps described above, which are performed by one or more computer systems. Each of the steps of the method may be performed as described further herein. The method may include any other step(s) of any other method(s) described herein. The method may be performed by any of the systems described herein.

An additional embodiment relates to a non-transitory computer-readable medium storing program instructions executable on a computer system for performing a computer-implemented method for constructing a ML library. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1-3 are schematic diagrams illustrating side views of embodiments of a system configured as described herein;

FIG. 4 is a flow chart illustrating an embodiment of the concept of architecture blocks and templates and steps that may be performed by the system embodiments described herein;

FIG. 5 is a flow chart illustrating an embodiment of the concept of choosing a loss function;

FIG. 6 is a flow chart illustrating an embodiment of a procedure for training a library by selecting a modularized architecture block and plug-in loss, and functional hyperparameter set;

FIG. 7 is a flow chart illustrating an embodiment of usage of functional hyperparameter sets in different architectures;

FIG. 8 is a flow chart illustrating an embodiment of processing signals based on wavelengths;

FIG. 9 is a flow chart illustrating an embodiment of processing signals based on Mueller components to measure overlay;

FIG. 10 is a flow chart illustrating an embodiment of processing signals based on subsystems;

FIG. 11 is a flow chart illustrating an embodiment of data feed forward to an architecture template;

FIG. 12 is a flow chart illustrating an embodiment of transfer learning using a pretrained model;

FIG. 13 is a flow chart illustrating an embodiment of domain adaption;

FIG. 14 is a flow chart illustrating an embodiment of a high aspect ratio structure template; and

FIG. 15 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are systems and methods for constructing a machine learning (ML) library. In addition, the embodiments described herein are configured for advanced neural network (NN) architectures. Although some embodiments may be described herein with respect to a NN or NNs, the embodiments are not limited in the ML models with which they can be used. For example, the embodiments described herein provide flexibility and extendibility of NN architectures and training algorithms. As a result, the embodiments enable the use of application-specific architectures that are well-matched with the application data and performance objectives.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, printed circuit boards (PCB), and other semiconductor specimens.

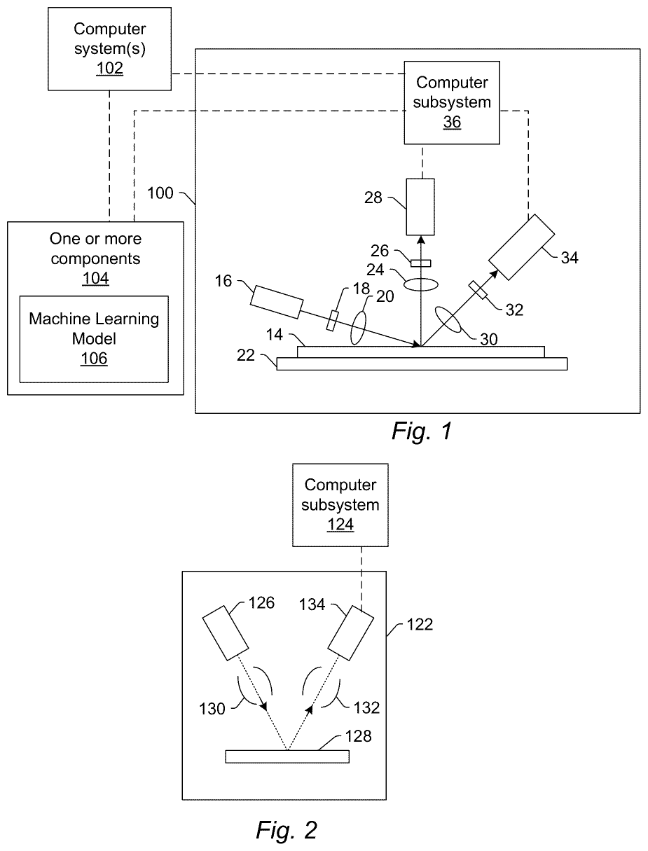

One embodiment of a system configured for determining information for a specimen is shown in FIG. 1. The system includes output acquisition subsystem 100. The output acquisition subsystem includes and/or is coupled to a computer subsystem, e.g., computer subsystem 36 and/or one or more computer systems 102.

In general, the output acquisition subsystems described herein include at least an energy source, a detector, and a scanning subsystem. The energy source is configured to generate energy that is directed to a specimen by the output acquisition subsystem. The detector is configured to detect energy from the specimen and to generate output responsive to the detected energy. The scanning subsystem is configured to change a position on the specimen to which the energy is directed and from which the energy is detected.

As shown in FIG. 1, the output acquisition subsystem may be configured as a light-based output acquisition subsystem. The energy directed to the specimen includes light, and the energy detected from the specimen includes light. The output acquisition subsystem includes an illumination subsystem configured to direct light to specimen 14. The illumination subsystem includes at least one light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the process being performed on the specimen.

The illumination subsystem may be configured to direct the light to the specimen at different angles of incidence at different times. The output acquisition subsystem may be configured to alter one or more characteristics of one or more elements of the illumination subsystem such that the light can be directed to the specimen at an angle of incidence that is different than that shown in FIG. 1. In one such example, the output acquisition subsystem may be configured to move light source 16, optical element 18, and lens 20 such that the light is directed to the specimen at a different oblique angle of incidence or a normal (or near normal) angle of incidence.

The output acquisition subsystem may be configured to direct light to the specimen at more than one angle of incidence at the same time. For example, the illumination subsystem may include more than one illumination channel, one of the illumination channels may include light source 16, optical element 18, and lens 20 as shown in FIG. 1 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen at different angles of incidence may be different such that light resulting from illumination of the specimen at the different angles of incidence can be discriminated from each other at the detector(s).

In another instance, the illumination subsystem may include only one light source (e.g., source 16 shown in FIG. 1) and light from the light source may be separated into different optical paths (e.g., based on wavelength, polarization, etc.) by one or more optical elements (not shown) of the illumination subsystem. Light in each of the different optical paths may then be directed to the specimen. Multiple illumination channels may be configured to direct light to the specimen at the same time or at different times (e.g., when different illumination channels are used to sequentially illuminate the specimen). In another instance, the same illumination channel may be configured to direct light to the specimen with different characteristics at different times. For example, optical element 18 may be configured as a spectral filter and the properties of the spectral filter can be changed in a variety of different ways (e.g., by swapping out one spectral filter with another) such that different wavelengths of light can be directed to the specimen at different times. The illumination subsystem may have any other suitable configuration known in the art for directing light having different or the same characteristics to the specimen at different or the same angles of incidence sequentially or simultaneously.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). The laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more of the elements of the illumination subsystem based on the type of illumination to be used for generating output.

The output acquisition subsystem may also include a scanning subsystem configured to change the position on the specimen to which the light is directed and from which the light is detected and possibly to cause the light to be scanned over the specimen. For example, the output acquisition subsystem may include stage 22 on which specimen 14 is disposed during output generation. The scanning subsystem may include any suitable mechanical and/or robotic assembly (that includes stage 22) that can be configured to move the specimen such that the light can be directed to and detected from different positions on the specimen. In addition, or alternatively, the output acquisition subsystem may be configured such that one or more optical elements of the output acquisition subsystem perform some scanning of the light over the specimen such that the light can be directed to and detected from different positions on the specimen. The light may be scanned over the specimen in any suitable fashion such as in a serpentine-like path or in a spiral path.

Any of the output acquisition subsystems described herein may be configured to generate output for a specimen at one or more target locations on the specimen. The one or more target locations may be predetermined target locations that are stored in a recipe for the process performed on the specimen with the output acquisition subsystem. The one or more target locations may also be discrete locations such as those used in move-acquire-measure type measurement processes or defined by areas on the specimen to be scanned as in an inspection or scanning type process. In this manner, the target locations indicate where on a specimen a process is supposed to be performed.

The output acquisition subsystem includes one or more detection channels. At least one of the detection channel(s) includes a detector configured to detect light from the specimen due to illumination of the specimen by the output acquisition subsystem and to generate output responsive to the detected light. The output acquisition subsystem shown in FIG. 1 includes two detection channels, one formed by collector 24, element 26, and detector 28 and another formed by collector 30, element 32, and detector 34. As shown in FIG. 1, the two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

As further shown in FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

The output acquisition subsystem may include a different number of detection channels (e.g., only one detection channel or two or more detection channels). In one such instance, the detection channel formed by collector 30, element 32, and detector 34 may form one side channel as described above, and the output acquisition subsystem may include an additional detection channel (not shown) formed as another side channel that is positioned on the opposite side of the plane of incidence. Therefore, the output acquisition subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the output acquisition subsystem may also include two or more side channels configured as described above. As such, the output acquisition subsystem may include at least three channels (i.e., one top channel and two side channels), and each of the at least three channels has its own collector, each of which is configured to collect light at different scattering angles than each of the other collectors.

As described further above, each of the detection channels included in the output acquisition subsystem may be configured to detect scattered light. Therefore, the output acquisition subsystem may be configured for dark field (DF) imaging of specimens. However, the output acquisition subsystem may also or alternatively include detection channel(s) that are configured for bright field (BF) imaging of specimens. In other words, the output acquisition subsystem may include at least one detection channel that is configured to detect light specularly reflected from the specimen. Therefore, the output acquisition subsystems described herein may be configured for only DF, only BF, or both DF and BF imaging. Although each of the collectors are shown in FIG. 1 as single refractive optical elements, each of the collectors may include one or more refractive optical elements and/or one or more reflective optical elements.

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels may be signals or data, but not image signals or image data. In such instances, a computer subsystem such as computer subsystem 36 may be configured to generate images of the specimen from the non-imaging output of the detectors. However, in other instances, the detectors may be configured as imaging detectors that are configured to generate imaging signals or image data. Therefore, the output acquisition subsystem may be configured to generate images in a number of ways.

FIG. 1 is provided herein to generally illustrate a configuration of an output acquisition subsystem that may be included in the system embodiments described herein. Obviously, the output acquisition subsystem configuration described herein may be altered to optimize the performance of the output acquisition subsystem as is normally performed when designing a commercial system. In addition, the systems described herein may be implemented using an existing system (e.g., by adding functionality described herein to an existing system) such as the 29xx/39xx series of tools that are commercially available from KLA Corp., Milpitas, Calif. For some such systems, the methods described herein may be provided as optional functionality of the system (e.g., in addition to other functionality of the system). Alternatively, the system described herein may be designed “from scratch” to provide a completely new system.

Computer subsystem 36 may be coupled to the detectors of the output acquisition subsystem in any suitable manner (e.g., via one or more transmission media, which may include “wired” and/or “wireless” transmission media) such that the computer subsystem can receive the output generated by the detectors. Computer subsystem 36 may be configured to perform a number of functions with or without the output of the detectors including the steps and functions described further herein. As such, the steps described herein may be performed “on-tool,” by a computer subsystem that is coupled to or part of an output acquisition subsystem. In addition, or alternatively, computer system(s) 102 may perform one or more of the steps described herein. Therefore, one or more of the steps described herein may be performed “off-tool,” by a computer system that is not directly coupled to an output acquisition subsystem. Computer subsystem 36 and computer system(s) 102 may be further configured as described herein.

Computer subsystem 36 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 36 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

The output acquisition subsystem may alternatively be configured as an electron-based output acquisition subsystem. In an electron beam subsystem, the energy directed to the specimen includes electrons, and the energy detected from the specimen includes electrons. As shown in FIG. 2, the output acquisition subsystem includes electron column 122, and the system includes computer subsystem 124 coupled to the output acquisition subsystem. Computer subsystem 124 may be configured as described above. In addition, such an output acquisition subsystem may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam subsystem may be configured to use multiple modes to generate output for the specimen as described further herein (e.g., with different illumination angles, collection angles, etc.). The multiple modes of the electron beam subsystem may be different in any output generation parameters of the output acquisition subsystem.

Computer subsystem 124 may be coupled to detector 134 as described above. The detector may detect electrons returned from the surface of the specimen thereby forming electron beam images of (or other output for) the specimen. The electron beam images may include any suitable electron beam images. Computer subsystem 124 may be configured to determine information for the specimen using output generated by detector 134, which may be performed as described further herein. Computer subsystem 124 may be configured to perform any additional step(s) described herein. A system that includes the output acquisition subsystem shown in FIG. 2 may be further configured as described herein.

FIG. 2 is provided herein to generally illustrate a configuration of an electron beam subsystem that may be included in the embodiments described herein. As with the optical subsystem described above, the electron beam subsystem configuration described herein may be altered to optimize the performance of the output acquisition subsystem as is normally performed when designing a commercial system. In addition, the systems described herein may be implemented using an existing system (e.g., by adding functionality described herein to an existing system) such as tools that are commercially available from KLA. For some such systems, the methods described herein may be provided as optional functionality of the system (e.g., in addition to other functionality of the system). Alternatively, the system described herein may be designed “from scratch” to provide a completely new system.

Although the output acquisition subsystem is described above as being a light or electron beam subsystem, the output acquisition subsystem may be an ion beam output acquisition subsystem. Such an output acquisition subsystem may be configured as shown in FIG. 2 except that the electron beam source may be replaced with any suitable ion beam source known in the art. In addition, the output acquisition subsystem may include any other suitable ion beam system such as those included in commercially available focused ion beam (FIB) systems, helium ion microscopy (HIM) systems, and secondary ion mass spectroscopy (SIMS) systems.

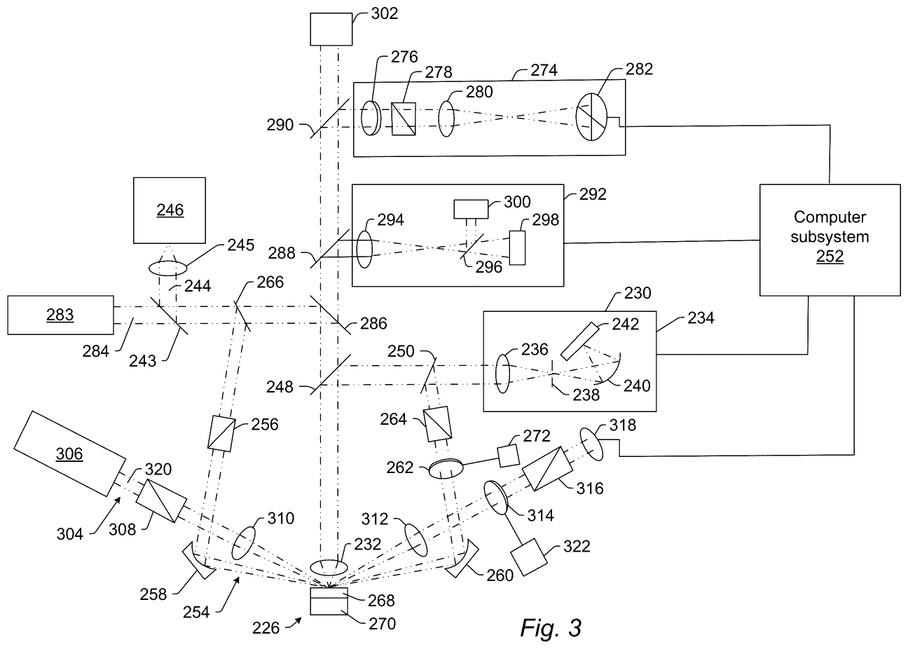

FIG. 3 illustrates another embodiment of a system that includes various light-based output acquisition subsystems. The output acquisition subsystems shown in FIG. 3 are described in more detail in U.S. Pat. No. 6,515,746 to Opsal et al., which is incorporated by reference as if fully set forth herein. Some of the non-essential details of the system presented in this patent have been omitted from the description corresponding to FIG. 3 presented herein. However, it is to be understood that the system illustrated in FIG. 3 may be further configured as described in this patent. In addition, it will be obvious upon reading the description of several embodiments provided herein that the system illustrated in FIG. 3 has been altered to improve upon the system described in U.S. Pat. No. 6,515,746 to Opsal et al.

One of the output acquisition subsystems is configured as a broadband reflective spectrometer. Broadband reflective spectrometer (BRS) 230 simultaneously probes specimen 226 with multiple wavelengths of light. BRS 230 uses lens 232 and includes a broadband spectrometer 234 which can be of any type commonly known and used in the art. Lens 232 may be a transmissive optical component formed of a material such as calcium fluoride (CaF₂). Such a lens may be a spherical, microscope objective lens with a high numerical aperture (on the order of 0.90 NA) to create a large spread of angles of incidence with respect to the specimen surface, and to create a spot size of about one micron in diameter. Alternatively, lens 232 may be a reflective optical component. Such a lens may have a lower numerical aperture (on the order of 0.4 NA) and may be capable of focusing light to a spot size of about 10-15 microns. Spectrometer 234 shown in FIG. 3 includes lens 236, aperture 238, dispersive element 240, and detector array 242. Lens 236 may be formed of CaF₂.

During operation, probe beam 244 from light source 246 is collimated by lens 245, directed by mirror 243 through mirror 266 to mirror 286, which directs the light through mirror 248 to lens 232, which is then focused onto specimen 226 by lens 232. The light source may include any of the light sources described above. Lens 245 may be formed of CaF₂.

Light reflected from the surface of the specimen passes through lens 232 and is directed by mirror 248 (through mirror 250) to spectrometer 234. Lens 236 focuses the probe beam through aperture 238, which defines a spot in the field of view on the specimen surface to analyze. Dispersive element 240, such as a diffraction grating, prism, or holographic plate, angularly disperses the beam as a function of wavelength to individual detector elements contained in detector array 242.

The different detector elements measure the optical intensities of different wavelengths of light contained in the probe beam, preferably simultaneously. Alternately, detector 242 can be a charge-coupled device (“CCD”) camera or a photomultiplier with suitably dispersive or otherwise wavelength selective optics. It should be noted that a monochrometer could be used to measure the different wavelengths serially (one wavelength at a time) using a single detector element. Further, dispersive element 240 can also be configured to disperse the light as a function of wavelength in one direction, and as a function of the angle of incidence with respect to the specimen surface in an orthogonal direction, so that simultaneous measurements as a function of both wavelength and angle of incidence are possible. Computer subsystem 252 processes the intensity information measured by detector array 242.

Broadband spectroscopic ellipsometer (BSE) 254 is also configured to perform measurements of the specimen using light. BSE 254 includes polarizer 256, focusing mirror 258, collimating mirror 260, rotating compensator 262, and analyzer 264. In some embodiments, BSE 254 may be configured to perform measurements of the specimen using light provided by light source 246, light source 283, or another light source (not shown).

In operation, mirror 266 directs at least part of probe beam 244 to polarizer 256, which creates a known polarization state for the probe beam, preferably a linear polarization. Mirror 258 focuses the beam onto the specimen surface at an oblique angle, ideally on the order of 70 degrees to the normal of the specimen surface. Based upon well known ellipsometric principles, the reflected beam will generally have a mixed linear and circular polarization state after interacting with the specimen, based upon the composition and thickness of the specimen's film 268 and substrate 270.

The reflected beam is collimated by mirror 260, which directs the beam to rotating compensator 262. Compensator 262 introduces a relative phase delay 8 (phase retardation) between a pair of mutually orthogonal polarized optical beam components. Compensator 262 is rotated at an angular velocity c about an axis substantially parallel to the propagation direction of the beam, preferably by electric motor 272. Analyzer 264, preferably another linear polarizer, mixes the polarization states incident on it. By measuring the light transmitted by analyzer 264, the polarization state of the reflected probe beam can be determined.

Mirror 250 directs the beam to spectrometer 234, which simultaneously measures the intensities of the different wavelengths of light in the reflected probe beam that pass through the compensator/analyzer combination. Computer subsystem 252 receives the output of detector 242, and processes the intensity information measured by detector 242 as a function of wavelength and as a function of the azimuth (rotational) angle of compensator 262 about its axis of rotation, to solve the ellipsometric values y and A as described in U.S. Pat. No. 5,877,859 to Aspnes et al., which is incorporated by reference as if fully set forth herein.

A system that includes the BRS and BSE described above may also include additional output acquisition subsystem(s) configured to perform additional measurements of the specimen using light. For example, the system may include output acquisition subsystems configured as a beam profile ellipsometer, a beam profile reflectometer, another optical subsystem, or a combination thereof.

Beam profile ellipsometry (BPE) is discussed in U.S. Pat. No. 5,181,080 to Fanton et al., which is incorporated by reference as if fully set forth herein. BPE 274 includes laser 283 that generates probe beam 284. Laser 283 may be a solid state laser diode from Toshiba Corp. which emits a linearly polarized 3 mW beam at 673 nm. BPE 274 also includes quarter wave plate 276, polarizer 278, lens 280, and quad detector 282. In operation, linearly polarized probe beam 284 is focused on specimen 226 by lens 232. Light reflected from the specimen surface passes up through lens 232 and mirrors 248, 286, and 288, and is directed into BPE 274 by mirror 290.

The position of the rays within the reflected probe beam correspond to specific angles of incidence with respect to the specimen's surface. Quarter-wave plate 276 retards the phase of one of the polarization states of the beam by 90 degrees. Linear polarizer 278 causes the two polarization states of the beam to interfere with each other. For maximum signal, the axis of polarizer 278 should be oriented at an angle of 45 degrees with respect to the fast and slow axis of quarter-wave plate 276. Detector 282 is a quad-cell detector with four radially disposed quadrants that each intercept one quarter of the probe beam and generate a separate output signal proportional to the power of the portion of the probe beam striking that quadrant.

The output signals from each quadrant are sent to computer subsystem 252. By monitoring the change in the polarization state of the beam, ellipsometric information, such as y and A, can be determined. To determine this information, computer subsystem 252 takes the difference between the sums of the output signals of diametrically opposed quadrants, a value which varies linearly with film thickness for very thin films.

Beam profile reflectometry (BPR) is discussed in U.S. Pat. No. 4,999,014 to Gold et al., which is incorporated by reference as if fully set forth herein. BPR 292 includes laser 283, lens 294, beam splitter 296, and two linear detector arrays 298 and 300 to measure the reflectance of the sample. In operation, linearly polarized probe beam 284 is focused onto specimen 226 by lens 232, with various rays within the beam striking the specimen surface at a range of angles of incidence. Light reflected from the specimen surface passes up through lens 232 and mirrors 248 and 286, and is directed into BPR 292 by mirror 288. The position of the rays within the reflected probe beam correspond to specific angles of incidence with respect to the specimen's surface. Lens 294 spatially spreads the beam two-dimensionally. Beam splitter 296 separates the S and P components of the beam, and detector arrays 298 and 300 are oriented orthogonal to each other to isolate information about S and P polarized light. The higher angles of incidence rays will fall closer to the opposed ends of the arrays. The output from each element in the diode arrays will correspond to different angles of incidence. Detectors arrays 298 and 300 measure the intensity across the reflected probe beam as a function of the angle of incidence with respect to the specimen surface. Computer subsystem 252 receives the output of detector arrays 298 and 300, and derives the thickness and refractive index of thin film layer 268 based on these angular dependent intensity measurements by utilizing various types of modeling algorithms. Optimization routines which use iterative processes such as least square fitting routines are typically employed.

The system shown in FIG. 3 may also include additional components such as detector/camera 302. Detector/camera 302 is positioned above mirror 290, and can be used to view reflected beams off of specimen 226 for alignment and focus purposes.

In order to calibrate BPE 274, BPR 292, BRS 230, and BSE 254, the system may include wavelength stable calibration reference ellipsometer 304 used in conjunction with a reference sample (not shown), which may be any appropriate sample of known parameters.

Ellipsometer 304 includes light source 306, polarizer 308, lenses 310 and 312, rotating compensator 314, analyzer 316, and detector 318. Compensator 314 is rotated about an axis substantially parallel to the propagation direction of beam 320, preferably by electric motor 322. The compensator can be located either between the specimen and the analyzer (as shown in FIG. 3) or between the specimen and polarizer 308. Polarizer 308, lenses 310 and 312, compensator 314, and polarizer 316 are all optimized in their construction for the specific wavelength of light produced by light source 306, which maximizes the accuracy of the ellipsometer.

Light source 306 produces a quasi-monochromatic probe beam 320 having a known stable wavelength and stable intensity. This can be done passively, where light source 306 generates a very stable output wavelength which does not vary over time (i.e., varies less than 1%). Examples of passively stable light sources are a helium-neon laser, or other gas discharge laser systems. Alternately, a non-passive system can be used where the light source includes a light generator (not shown) that produces light having a wavelength that is not precisely known or stable over time, and a monochrometer (not shown) that precisely measures the wavelength of light produced by the light generator. Examples of such light generators include laser diodes, or polychromatic light sources used in conjunction with a color filter such as a grating. In either case, the wavelength of beam 320, which is a known constant or measured by a monochrometer, is provided to computer subsystem 252 so that ellipsometer 304 can accurately calibrate the optical measurement devices in the system.

Operation of ellipsometer 304 during calibration is further described in U.S. Pat. No. 6,515,746. Briefly, beam 320 enters detector 318, which measures the intensity of the beam passing through the compensator/analyzer combination. Computer subsystem 252 processes the intensity information measured by detector 318 to determine the polarization state of the light after interacting with the analyzer, and therefore the ellipsometric parameters of the specimen. This information processing includes measuring beam intensity as a function of the azimuth (rotational) angle of the compensator about its axis of rotation. This measurement of intensity as a function of compensator rotational angle is effectively a measurement of the intensity of beam 320 as a function of time, since the compensator angular velocity is usually known and constant.

By knowing the composition of the reference sample, and by knowing the exact wavelength of light generated by light source 306, the optical properties of the reference sample such as film thickness d, refractive index and extinction coefficients, etc., can be determined by ellipsometer 304. Once the thickness d of the film has been determined by ellipsometer 304, then the same sample is probed by the other optical measurement devices BPE 274, BPR 292, BRS 230, and BSE 254 which measure various optical parameters of the sample. Computer subsystem 252 then calibrates the processing variables used to analyze the results from these optical measurement devices so that they produce accurate results. In the above described calibration techniques, all system variables affecting phase and intensity are determined and compensated for using the phase offset and reflectance normalizing factor discussed in U.S. Pat. No. 6,515,746, thus rendering the optical measurements made by these calibrated optical measurement devices absolute.

The above described calibration techniques are based largely upon calibration using the derived thickness d of the thin film. However, calibration using ellipsometer 304 can be based upon any of the optical properties of the reference sample that are measurable or determinable by ellipsometer 304 and/or are otherwise known, whether the sample has a single film thereon, has multiple films thereon, or even has no film thereon (bare sample).

In some embodiments, the output acquisition subsystems may have at least one common optical component. For example, lens 232 is common to BPE 274, BPR 292, BRS 230, and BSE 254. In a similar manner, mirrors 243, 266, 286, and 248 are common to BPE 274, BPR 292, BRS 230, and BSE 254. Ellipsometer 304, as shown in FIG. 3, does not have any optical components that are common to the other output acquisition subsystems. Such separation from the other output acquisition subsystems may be appropriate since the ellipsometer is used to calibrate the other output acquisition subsystems.

As further noted above, the output acquisition subsystem may be configured to have multiple modes. In general, a “mode” is defined by the values of parameters of the output acquisition subsystem used to generate output for the specimen. Therefore, modes that are different may be different in the values for at least one of the output generation parameters of the output acquisition subsystem (other than position on the specimen at which the output is generated). For example, for a light-based output acquisition subsystem, different modes may use different wavelengths of light. The modes may be different in the wavelengths of light directed to the specimen as described further herein (e.g., by using different light sources, different illumination channels, different spectral filters, etc. for different modes).

The multiple modes may also be different in illumination and/or collection/detection. For example, as described further above, the output acquisition subsystem may include multiple detectors. One of the detectors may be used for one mode and another of the detectors may be used for another mode. Furthermore, the modes may be different from each other in more than one way described herein (e.g., different modes may have one or more different illumination parameters and one or more different detection parameters). In addition, the multiple modes may be different in perspective, meaning having either or both of different angles of incidence and angles of collection, which are achievable as described further above. The output acquisition subsystem may be configured to scan the specimen with the different modes in the same scan or different scans, e.g., depending on the capability of using multiple modes to scan the specimen at the same time.

In some instances, the systems described herein may be configured as inspection systems. However, the systems described herein may be configured as another type of semiconductor-related quality control type system such as a defect review system and a metrology system. For example, the embodiments of the output acquisition subsystems described herein and shown in FIGS. 1-3 may be modified in one or more parameters to provide different output generation capability depending on the application for which they will be used. In one embodiment, the output acquisition subsystem is configured as an electron beam defect review subsystem. For example, the output acquisition subsystem shown in FIG. 2 may be configured to have a higher resolution if it is to be used for defect review or metrology rather than for inspection. In other words, the embodiments of the output acquisition subsystem shown in FIGS. 1-3 describe some general and various configurations for an output acquisition subsystem that can be tailored in a number of manners that will be obvious to one skilled in the art to produce output acquisition subsystems having different output generation capabilities that are more or less suitable for different applications.

As noted above, the output acquisition subsystem may be configured for directing energy (e.g., light, electrons) to and/or scanning energy over a physical version of the specimen thereby generating actual output for the physical version of the specimen. In this manner, the output acquisition subsystem may be configured as an “actual” output acquisition system, rather than a “virtual” system. However, a storage medium (not shown) and computer system(s) 102 shown in FIG. 1 and/or other computer subsystems shown and described herein may be configured as a “virtual” system. In particular, the storage medium and computer system(s) 102 are not part of output acquisition subsystem 100 and do not have any capability for handling the physical version of the specimen but may be configured as a virtual inspector that performs inspection-like functions, a virtual metrology system that performs metrology-like functions, a virtual defect review tool that performs defect review-like functions, etc. using stored detector output. Systems and methods configured as “virtual” systems are described in commonly assigned U.S. Pat. No. 8,126,255 issued on Feb. 28, 2012 to Bhaskar et al., U.S. Pat. No. 9,222,895 issued on Dec. 29, 2015 to Duffy et al., and U.S. Pat. No. 9,816,939 issued on Nov. 14, 2017 to Duffy et al., which are incorporated by reference as if fully set forth herein. The embodiments described herein may be further configured as described in these patents

In one embodiment, the output acquisition subsystem is configured as a metrology subsystem. As described above, the output acquisition subsystems shown in FIGS. 1-3 may be configured as metrology subsystems, and the systems described herein may be configured as metrology tools. In the field of semiconductor metrology, a metrology tool may include an illumination subsystem which illuminates a target, a collection subsystem which captures relevant information provided by the illumination subsystem's interaction (or lack thereof) with a target, device or feature, and a computer subsystem which analyzes the information collected using one or more algorithms. Metrology tools can be used to measure structural and material characteristics (e.g., material composition, dimensional characteristics of structures and films such as film thickness and/or critical dimensions (CDs) of structures, overlay, etc.) associated with various semiconductor fabrication processes. These measurements are used to facilitate process control and/or yield efficiencies in the manufacture of semiconductor dies.

The metrology tool can include one or more hardware configurations which may be used in conjunction with certain embodiments described herein to, e.g., measure the various aforementioned semiconductor structural and material characteristics. Examples of such hardware configurations include, but are not limited to, the following.
1. Spectroscopic ellipsometer (SE)
2. SE with multiple angles of illumination
3. SE measuring Mueller matrix elements (e.g. using rotating compensator(s))
4. Single-wavelength ellipsometers
5. Beam profile ellipsometer (angle-resolved ellipsometer)
6. Beam profile reflectometer (angle-resolved reflectometer)
7. Broadband reflective spectrometer (spectroscopic reflectometer)
8. Single-wavelength reflectometer
9. Angle-resolved reflectometer
10. Imaging system
11. Scatterometer (e.g. speckle analyzer)

The hardware configurations can be separated into discrete operational systems. On the other hand, one or more hardware configurations can be combined into a single tool. One example of combining multiple hardware configurations into a single tool is shown in FIG. 3, which may be further configured as described in U.S. Pat. No. 7,933,026 to Opsal et al., which is incorporated by reference as if fully set forth herein. The systems described herein may be further configured as described in this reference.

FIG. 3 shows, for example, a schematic of an exemplary metrology tool that comprises: a) a BSE (i.e., 254); b) a SE (i.e., 304) with rotating compensator (i.e., 314); c) a BPE (i.e., 274); d) a BPR (i.e., 292); e) a BRS (i.e., 230); and f) a deep ultraviolet reflective spectrometer (i.e., 230). In addition, there are typically numerous optical elements in such systems, including certain lenses, collimators, mirrors, quarter-wave plates, polarizers, detectors, cameras, apertures, and/or light sources. The wavelengths for optical systems can vary from about 120 nm to 3 microns. For non-ellipsometer systems, signals collected can be polarization-resolved or unpolarized. FIG. 3 provides an illustration of multiple metrology heads integrated on the same tool. However, in many cases, multiple metrology tools are used for measurements on a single or multiple metrology targets, which is described, e.g. in U.S. Pat. No. 7,478,019 to Zangooie et al, which is incorporated by reference as if fully set forth herein. The embodiments described herein may be further configured as described in this reference.

The illumination subsystem of the certain hardware configurations includes one or more light sources. The light source may generate light having only one wavelength (i.e., monochromatic light), light having a number of discrete wavelengths (i.e., polychromatic light), light having multiple wavelengths (i.e., broadband light) and/or light that sweeps through wavelengths, either continuously or hopping between wavelengths (i.e., tunable sources or swept sources). Examples of suitable light sources include, but are not limited to, a white light source, an ultraviolet (UV) laser, an arc lamp or an electrode-less lamp, a laser sustained plasma (LSP) source such as those commercially available from Energetiq Technology, Inc., Woburn, Massachusetts, a supercontinuum source (such as a broadband laser source) such as those commercially available from NKT Photonics Inc., Morganville, New Jersey, or shorter-wavelength sources such as x-ray sources, extreme UV sources, or some combination thereof. The light source may also be configured to provide light having sufficient brightness, which in some cases may be a brightness greater than about 1 W/(nm cm² Sr). The metrology system may also include a fast feedback to the light source for stabilizing its power and wavelength. Output of the light source can be delivered via free-space propagation, or in some cases delivered via optical fiber or light guide of any type.

The metrology tool may be designed to make many different types of measurements related to semiconductor manufacturing. Certain embodiments described herein may be applicable to such measurements. For example, in certain embodiments, the tool may measure characteristics of one or more targets, such as CDs, overlay, sidewall angles, film thicknesses, process-related parameters (e.g., focus and/or dose). The targets can include regions of interest that are periodic in nature such as, for example, gratings in a memory die. Targets can include multiple layers (or films) whose thicknesses can be measured by the metrology tool. Targets can include target designs placed (or already existing) on the specimen for use, e.g., with alignment and/or overlay registration operations. Certain targets can be located at various places on the specimen. For example, targets can be located within the scribe lines (e.g., between dies) and/or located in the die itself. Multiple targets may be measured (at the same time or at differing times) by the same or multiple metrology tools as described in U.S. Pat. No. 7,478,019 to Zangooie et al. The data from such measurements may be combined. Data from the metrology tool is used in the semiconductor manufacturing process for example to feed-forward, feed-backward and/or feed-sideways corrections to the process (e.g. lithography, etch) and therefore, might yield a complete process control solution.

As semiconductor device pattern dimensions continue to shrink, smaller metrology targets are often required. The measurement accuracy and matching to actual device characteristics increase the need for device-like targets as well as in-die and even on-device measurements. Various metrology implementations have been proposed to achieve that goal. For example, focused beam ellipsometry based on primarily reflective optics is one of them and described in U.S. Pat. No. 5,608,526 to Piwonka-Corle et al., which is incorporated by reference as if fully set forth herein. The embodiments described herein may be further configured as described in this patent. Apodizers can be used to mitigate the effects of optical diffraction causing the spread of the illumination spot beyond the size defined by geometric optics. The use of apodizers is described in U.S. Pat. No. 5,859,424 to Norton, which is incorporated by reference as if fully set forth herein. The embodiments described herein may be further configured as described in this patent. The use of high-numerical-aperture tools with simultaneous multiple angle-of-incidence illumination is another way to achieve small-target capability. This technique is described, e.g., in U.S. Pat. No. 6,429,943 to Opsal et al, which is incorporated by reference as if fully set forth herein. The embodiments described herein may be further configured as described in this patent.

Other measurement examples may include measuring the composition of one or more layers of the semiconductor stack or the specimen, measuring certain defects on (or within) the specimen, and measuring the amount of photolithographic radiation exposed to the specimen. In some cases, metrology tool and algorithm may be configured for measuring non-periodic targets, see e.g. U.S. Pat. No. 9,291,554 to Kuznetsov et al. issued Mar. 22, 2016 and U.S. Pat. No. 9,915,522 to Jiang et al. issued Mar. 13, 2018, which are incorporated by reference as if fully set forth herein. The embodiments described herein may be further configured as described in these patents.

Measurement of parameters of interest usually involves a number of algorithms. For example, optical interaction of the incident beam with the specimen is modeled using EM (electro-magnetic) solver and uses such algorithms as RCWA, FEM, method of moments, surface integral method, volume integral method, FDTD, and others. The target of interest is usually modeled (parametrized) using a geometric engine or, in some cases, a process modeling engine or a combination of both. The use of process modeling is described in U.S. Pat. No. 10,769,320 to Kuznetsov et al. issued Sep. 8, 2020, which is incorporated by reference as if fully set forth herein. The embodiments described herein may be further configured as described in this patent. A geometric engine is implemented, for example, in the AcuShape software product of KLA.

Collected data can be analyzed by a number of data fitting and optimization techniques and technologies including libraries, Fast-reduced-order models; regression; machine-learning algorithms such as neural networks, support-vector machines (SVM); dimensionality-reduction algorithms such as, e.g., PCA (principal component analysis), ICA (independent component analysis), LLE (local-linear embedding); sparse representation such as Fourier or wavelet transform; Kalman filter; algorithms to promote matching from same or different tool types, and others.

Collected data can also be analyzed by algorithms that do not include modeling, optimization and/or fitting as described, for example, in U.S. Pat. No. 10,591,406 to Bringoltz et al. issued Mar. 17, 2020, which is incorporated by reference as if fully set forth herein. The embodiments described herein may be further configured as described in this patent.

Computational algorithms are usually optimized for metrology applications with one or more approaches being used such as design and implementation of computational hardware, parallelization, distribution of computation, load-balancing, multi-service support, dynamic load optimization, etc. Different implementations of algorithms can be done in firmware, software, FPGA, programmable optics components, etc.

The data analysis and fitting steps usually pursue one or more of the following goals:
1. Measurement of CD, side wall angle (SWA), shape, stress, composition, films, bandgap, electrical properties, focus/dose, overlay, generating process parameters (e.g., resist state, partial pressure, temperature, focusing model), and/or any combination thereof;
2. Modeling and/or design of metrology systems; and
3. Modeling, design, and/or optimization of metrology targets.

The embodiments described herein configured for the field of semiconductor metrology are not limited to the hardware, algorithm/software implementations and architectures, and use cases summarized above.

In another embodiment, the output acquisition subsystem is configured as an inspection subsystem. The inspection subsystem may be configured for performing inspection using light, electrons, or another energy type such as ions. Such an output acquisition subsystem may be configured, for example, as shown in FIGS. 1 and 2. In systems in which the output acquisition subsystem is configured as an inspection subsystem, the computer subsystem may be configured for detecting defects on the specimen based on the output generated by the output acquisition subsystem. For example, in possibly the simplest scenario, the computer subsystem may subtract a reference from the output thereby generating a difference signal or image and then apply a threshold to the difference signal or image. The computer subsystem may determine that any difference signal or image having a value above the threshold is a defect or potential defect and that any other difference signal or image is not a defect or potential defect. Of course, many defect detection methods and algorithms used on commercially available inspection tools are much more complicated than this example, and any such methods or algorithms may be applied to the output generated by the output acquisition subsystem configured as an inspection subsystem.

In a similar manner, the process may be a defect review process. Unlike inspection processes, a defect review process generally revisits discrete locations on a specimen at which a defect has been detected. An output acquisition subsystem configured for defect review may generate specimen images as described herein, which may be used to determine one or more attributes of the defect like a defect shape, dimensions, roughness, background pattern information, etc. and/or a defect classification (e.g., a bridging type defect, a missing feature defect, etc.). For defect review applications, the computer subsystem may be configured for using any suitable defect review method or algorithm to determine information for the defect or the specimen from the output generated by the output acquisition subsystem.

The system includes one or more components executed by the computer subsystem. For example, as shown in FIG. 1, the system includes one or more components 104 executed by computer subsystem 36 and/or computer system(s) 102. The one or more components may include machine learning model 106, which may include any of the architectures, architecture templates, architecture blocks, etc. described further herein. Systems shown in other figures described herein may be configured to include similar elements. The component(s) may be executed by the computer subsystem as described further herein or in any other suitable manner known in the art. At least part of executing the one or more components may include inputting one or more inputs, such as acquired metrology measurements, inspection images or signals, defect review images, etc. into the one or more components. The computer subsystem may be configured to input any such measurements, images, signals, etc. into the one or more components in any suitable manner. The term “component” as used herein can be generally defined as any software and/or hardware that can be executed by a computer system.

The embodiments described herein provide an important framework for advanced ML architectures. In addition, the embodiments described herein provide a framework that enables the construction of arbitrary architectures.

ML can be generally defined as a type of artificial intelligence (AI) that provides computers with the ability to learn without being explicitly programmed. ML focuses on the development of computer programs that can teach themselves to grow and change when exposed to new data. In other words, ML can be defined as the subfield of computer science that “gives computers the ability to learn without being explicitly programmed.” ML explores the study and construction of algorithms that can learn from and make predictions on data-such algorithms overcome following strictly static program instructions by making data driven predictions or decisions, through building a model from sample inputs.

The ML described herein may be further performed as described in “Introduction to Statistical Machine Learning,” by Sugiyama, Morgan Kaufmann, 2016, 534 pages; “Discriminative, Generative, and Imitative Learning,” Jebara, MIT Thesis, 2002, 212 pages; and “Principles of Data Mining (Adaptive Computation and Machine Learning),” Hand et al., MIT Press, 2001, 578 pages; which are incorporated by reference as if fully set forth herein. The embodiments described herein may be further configured as described in these references.

Generally speaking, “deep learning” (DL) (also known as deep structured learning, hierarchical learning or deep ML) is a branch of ML based on algorithms that attempt to model high level abstractions in data. In a simple case, there may be two sets of neurons: ones that receive an input signal and ones that send an output signal. When the input layer receives an input, it passes on a modified version of the input to the next layer. In a DL-based model, there are usually many layers between the input and output, allowing the algorithm to use multiple processing layers, composed of multiple linear and/or non-linear transformations.

The ML model may be configured as a generative model. A “generative” model can be generally defined as a model that is probabilistic in nature. In other words, a generative model is not one that performs forward simulation or rule-based approaches and, as such, a model of the physics of the processes involved is not necessary. Instead, as described further herein, the generative model can be learned (in that its parameters can be learned) based on a suitable training set of data. The ML model may also be configured as a deep generative model. For example, the model may be configured to have a DL architecture in that the model may include multiple layers, which perform a number of algorithms or transformations.

Any of the architectures, architecture templates, architecture blocks, etc. described herein may include a neural network (NN). NNs can be generally defined as a computational approach which is based on a relatively large collection of neural units. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Any of the architectures, architecture templates, architecture blocks, etc. described herein may include a convolutional neural network (CNN). The CNN may include any suitable types of layers such as convolution, pooling, fully connected, soft max, etc., layers having any suitable configuration known in the art. The CNN may have any suitable CNN configuration or architecture known in the art.

The system includes one or more computer systems (e.g., computer subsystem 36 and/or computer system(s) 102 shown in FIG. 1) configured for defining multiple architecture blocks, each of which is a reusable piece of ML architecture. For example, constructing the library of architectures may include defining multiple architecture blocks, which are common reusable pieces of architecture. For greater ease of use, the architectures may be constructed by architecture blocks that enhance the capabilities of the embodiments described herein by simplifying the definition of the architectures.

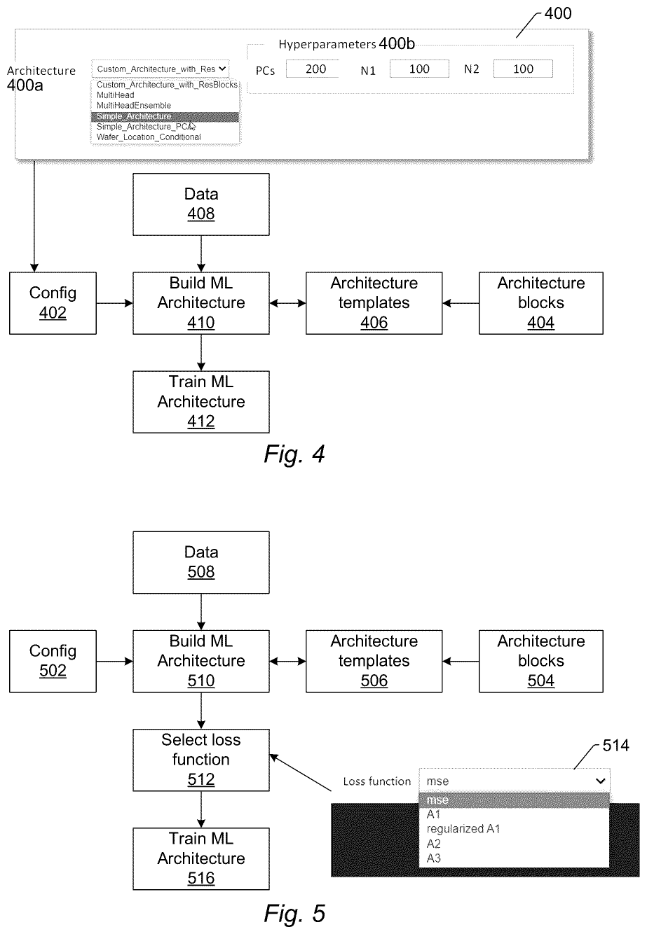

The computer system(s) are also configured for defining multiple architecture templates, each of which is a reusable template configurable for including one or more of the multiple architecture blocks. For example, the computer system(s) may be configured for defining multiple architecture templates that may use architecture blocks and hyperparameter (HP) definitions related to the architecture. FIG. 4 illustrates the concept of architecture blocks and templates. Architecture templates 406 and architecture blocks 404 may include user-defined descriptions of the templates and blocks, respectively.

Architecture blocks 404 may be input to architecture templates 406. In other words, one or more of the architecture blocks may be included in any one of the templates. In a sense then, one or more of the architecture blocks may be plugged into an architecture template. Since both the blocks and the templates are reusable, any one architecture block may be included in one or more of the architecture templates. In a similar manner, the same architecture template may be reused with different architecture block(s) depending on the input data metrics and performance objectives for an application. In addition, one combination of an architecture template and one or more of the blocks may be reused for multiple layers, applications, etc. by separately training it for different layers, applications, etc. so that different instances of the same architecture have (or are allowed to have) different values of parameter(s) of the architecture.

In one embodiment, the multiple architecture templates include at least one architecture template that is layer-specific, application-specific, or user-customized, and one or more characteristics of the at least one architecture template are modifiable to a different layer or application. For example, the architecture templates define the architectures and can be modified or extended for a specific purpose, without the need for code compilation or new release. The architecture templates may also be plugins to the main software. In one such example, an architecture template that is specific to one layer on one specimen may be modified to be useful for a different layer on a different specimen. In another such example, an architecture template that is specific to determining CDs of structures in metrology data may be extendable to determining CDs of defects or structures in defect review images.

In another embodiment, the multiple architecture blocks include at least one architecture block that is layer-specific, application-specific, or user-customized, and one or more characteristics of the at least one architecture block are modifiable to a different layer or application during the selecting step described herein. The architecture blocks may be modifiable and extendable as described above.

The computer system(s) are also configured for assigning metadata to the multiple architecture templates responsive to input data metrics and performance objectives for which the multiple architecture templates are suited. In this manner, each of the architecture templates may have metadata describing the use cases in which it can be used. The computer system(s) may be configured to assign the metadata to the templates in any suitable manner known in the art, and the metadata may have any suitable form or format known in the art. The input data metrics and performance objectives to which the metadata is responsive may include any of such metrics and objectives described herein. The computer system(s) may be configured to determine the input data metrics and performance objectives for which the templates are suited in any suitable manner, e.g., from a recipe in which the template was previously used, based on input from a user, etc. More specifically, the metadata may be responsive to the data that was previously input to the templates and the objectives (e.g., purpose) of generating the output with the templates.

The computer system(s) are further configured for storing the multiple architecture blocks, the multiple architecture templates, and the metadata in a ML library configured for use in selecting one or more of the multiple architecture templates for an application-specific ML architecture (ASMLA) (also simply referred to herein as an “architecture”) based on the input data metrics and the performance objectives specific to the application. In this manner, the embodiments may create a library of advanced ML or NN architectures. For example, all available (previously used or at least previously created) architecture templates and blocks may form a library of possible architectures. The selection of the ASMLA may be manual (the user selects it) or automatic (the computer system(s) select it) based on the application and the performance objectives.

Although the stored blocks, templates, metadata, etc. are referred to herein as a ML library, the computer system(s) may store the blocks, templates, metadata, etc. in any suitable data structure having any suitable form and format known in the art. The computer system(s) may be configured for storing the blocks, templates, metadata, etc. as described further herein and/or in any suitable manner known in the art.

In one embodiment, the computer system(s) are configured for performing the selecting step. For example, the same computer system that generates the ML library may also use the ML library to select block(s), template(s), etc. for an ASMLA. However, one computer system may only construct the ML library, while a different computer system may use the ML library for creating one or more ASMLAs. Any of such computer systems may be further configured as described herein.

In another embodiment, the computer system(s) are configured for defining HPs for the multiple architecture templates, assigning additional metadata to the HPs responsive to the input data metrics and the performance objectives for which the HPs are suited, and storing the HPs and the additional metadata in the ML library configured for use in selecting one or more of the HPs for the ASMLA based on the input data metrics and the performance objectives specific to the application. The HPs may include any of the HPs described further herein, and the additional metadata may be assigned to the HPs as described further herein. The HPs and their corresponding metadata may be stored in the ML library as described further herein. Selecting one or more of the HPs for the ASMLA may be performed as described further herein.

FIG. 4 shows an embodiment of a method for creating a specific architecture. The ASMLA may be created in build ML architecture step 410 based on architecture templates 406 that use architecture blocks 404. A user can select a specific configuration (e.g., Config 402) for the ASMLA (e.g., an iDO-specific configuration, an NAND-specific configuration, etc.), for example, using interface 400. For example, the user may choose from a library of advanced architectures for Config 402. As shown in FIG. 4, interface 400 may include architecture drop down menu 400a from which the user can select one specific configuration. Although the architecture drop down menu includes a few specific configurations (e.g., from top to bottom, “Custom_Architecture_with_ResBlocks,” “MultiHead,” “MultiHeadEnsemble,” “Simple_Architecture,” “Simple_Architecture_PCA,” and “Wafer_Location_Conditional”), the architecture drop down menu may include any configurations available for the application for which an ASMLA is being created.

Interface 400 may also include Hyperparameters section 400b, which may be configured for showing the HPs for a highlighted or selected configuration. In this manner, HPs section 400b may switch depending on which configuration is highlighted or selected by a user. In addition or alternatively, the HP section may be configured to allow a user to enter values for the HPs for the selected configuration. Although certain HP types are shown in FIG. 4 (e.g., from left to right, “PCs”, “N1”, and “N2”) with certain values for each of the HP types, the HP section may include any HP types and their values that are available for the selected configuration and the application for which an ASMLA is being created.

After the ASMLA has been built in step 410, the ASMLA may be trained with data 408 in train ML architecture step 412. The computer system(s) may be configured for training the ASMLA with a training set including training inputs and training outputs. The training set may include any appropriate data, which may vary depending on the application for which the ASMLA is being selected and setup. For example, the training inputs may include spectra measured on a metrology tool for one or more training wafers, and the training outputs may include ground truth metrology data such as CDs of structures formed on the training wafer(s) measured using a ground truth method such as CD scanning electron microscopy (CDSEM). In a different example, the training inputs may include images generated by a wafer inspection tool for one or more training wafers, and the training outputs may include ground truth defect information for the training wafer(s) generated using a ground truth tool such as a CDSEM or defect review SEM.

The training may include inputting the training inputs into the ASMLA and altering one or more parameters of the ASMLA until the output produced by the ASMLA matches (or substantially matches) the training outputs. Training may include altering any one or more trainable parameters of the ASMLA. The one or more parameters of the ASMLA that are trained may include one or more weights for any layer of the ASMLA that has trainable weights. In one such example, the weights may include weights for convolution layers but not pooling layers.

The ASMLA may or may not be trained by the computer system(s) and/or one of the component(s) executed by the computer system(s). For example, another method or system may train the ASMLA, which then may be stored for use as one of the component(s) executed by the computer system(s). In this manner, the ASMLA may be created by one system and trained by the same system or a different system.

In one such embodiment, the computer system(s) are configured for selecting the one or more of the multiple architecture templates and the one or more of the HPs for the ASMLA based on the input data metrics and the performance objectives specific to the application. For example, the type of HPs may be selected based on the architecture and the data and performance objectives. Some architectures could have very application-specific HPs. The computer system(s) or other computer system(s) may be configured to select the template(s) and the HP(s) as described further herein.

The embodiments described herein allow for defining high level HPs that are a function of other HPs. In other words, the HPs may be functional HPs. In one such embodiment, the HPs include functional HPs, and each of the functional HPs are a function of two or more of the HPs with a similar role. For example, the HPs may be a function of other HPs such as number of neurons, number of layers, etc. In this manner, the HPs may be functional HPs, and each (or two or more) of them may be a function of multiple HPs with a similar role (e.g., number of neurons, number of layers, etc.). HPs with a “similar role” are generally defined herein as HPs that are of the same type. Examples of such functional HPs include, but are not limited to, Neurons_L1, Neurons_L2, Neurons_L3=f (HP_Capacity, HP_Regularization), Dropout_L1, Dropout_L2, Dropout_L3, L2_Norm_L1, L2_Norm_L2, and L2_Norm_L3=f (HP_Capacity, HP_Regularization). All primary HPs depend on (some user-defined function of) the functional HPs: HP_Capacity, HP_Regularization. In this manner, the HP optimization described further herein can explore the space of the primary HP by changing only a few functional HP. In addition, functional HPs with a similar role have a stronger relationship to the performance metric. This enables users to interpret results easily and therefore to optimize the model given less HP search (time to solution improvement) or to the tune the library quickly.

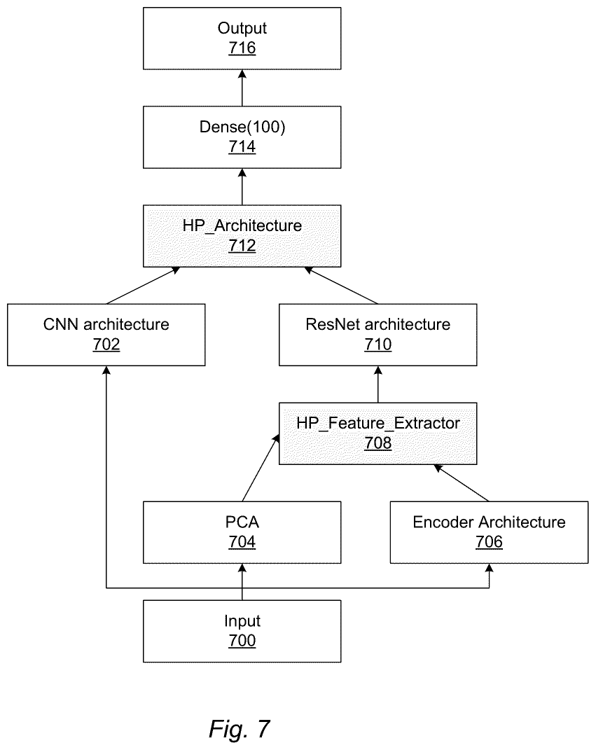

In an additional such embodiment, at least one of the HPs is configured for selecting the one or more of the multiple architecture templates for the ASMLA based on the input data metrics and the performance objectives specific to the application. For example, the HPs can select specific architectures or a subset of architectures. More specifically, the embodiments allow definition of HP(s) that play a role of a switch in selecting different architectures or part of the architectures during the HP optimization. This capability allows for full exploration of the architectures and combinations of architectures. FIG. 7 shows an architecture that uses HPs that select different architectures.

FIG. 7 also shows the usage of functional HP sets in different architectures. Input 700, which may include input data, input data metrics, and performance objectives, is provided to CNN architecture 702, PCA 704, and encoder architecture 706, each of which may have any suitable configuration. The output of PCA 704 and encoder architecture 706 may be input to HP_Feature_Extractor 708. The output of HP_Feature_Extractor 708 may be passed through ResNet architecture 710, and the outputs of this architecture and CNN architecture 702 may be input to HP_Architecture 712. The shaded blocks (HP_Feature_Extractor 708 and HP_Architecture 712) are the HPs that determine the type of architecture and feature extractor that will be used for the specific instance of the architecture.

The output of HP_Architecture 712 may be passed through Dense(100) layer 714, which may then produce output 716. A “dense” layer or block architecture is a commonly used fundamental ML architecture. Such architectures are also known as fully connected layers. In this layer, each of the neurons are connected to every neuron in the previous layer. All of the dense layers or architectures described herein are just examples to illustrate what the ASMLA may look like.

In a further such embodiment, at least one of the HPs is configured for controlling one or more characteristics and one or more capabilities of the ASMLA. For example, the HPs can control certain high level aspects of the structure and capabilities of the ASMLA. Such HPs may be further configured as described herein.

In some such embodiments, the at least one of the HPs includes a capacity HP configured for controlling total capacity of the ASMLA by changing one or more properties of the ASMLA. For example, HP_Capacity controls the total capacity of the ASMLA by changing properties such as number of layers, number of neurons per layer, input features, etc. In other words, HP_Capacity is a functional HP that can control the number of parameters (number of weights) of the ASMLA.

In another embodiment, the at least one of the HPs includes a regularization HP configured for controlling regularization of the ASMLA by changing one or more properties of the ASMLA. For example, HP_Regularization controls the regularization in the ASMLA by changing properties such as dropout rate, L2, L1 regularization coefficients, layer normalization, and batch normalization parameters. In other words, HP_Regularization is a functional HP that can control the elements of the ASMLA related to regularization (L1, L2 regularization, Dropout, Batch or Layer normalization, bottle neck layers, etc.).

In an additional embodiment, the at least one of the HPs includes an aspect ratio HP configured for controlling depth and width of layers of the ASMLA and total number of the layers. For example, HP_Aspect_Ratio can control the depth vs. width of the layers of the ASMLA and maintain similar total number of parameters (weights). In other words, HP_Depth is a functional HP that can control the depth of the ASMLA and may change parameters related to the architecture such as a CNN and residual layers. HP_AspectRatio is a functional HP that is similar to HP_Depth, but maintains the total ASMLA in a similar manner.

In a further embodiment, the computer system(s) are configured for defining multiple loss functions, assigning additional metadata to the multiple loss functions responsive to the input data metrics and the performance objectives for which the multiple loss functions are suited, and storing the multiple loss functions and the additional metadata in the ML library configured for use in selecting one or more of the multiple loss functions for the ASMLA based on the input data metrics and the performance objectives specific to the application. In this manner, constructing the library of architectures may include defining multiple loss functions, each one with metadata describing the use cases it will be used for. The loss functions may include any of the loss functions described further herein, and the additional metadata may be assigned to the loss functions as described further herein. The loss functions and their corresponding metadata may be stored in the ML library as described further herein. Selecting one or more of the loss functions for the ASMLA may be performed as described further herein.

In one such embodiment, the computer system(s) are configured for selecting the one or more of the multiple architecture templates and the one or more of the multiple loss functions for the ASMLA based on the input data metrics and the performance objectives specific to the application. The loss function may be chosen before starting to train the ASMLA that has been selected, as shown in FIG. 5. For example, a user may select a configuration, e.g., Config 502, as described further above, and architecture blocks 504 and architecture templates 506 may be configured and selected as described above. The ASMLA may be created in build ML architecture step 510 based on Config 502, architecture blocks 504, and architecture templates 506 as described further above. Data 508 may be input to the created ASMLA for training as described above, but before train ML architecture step 516, the computer system(s) may perform select loss function step 512. The loss function may be selected in step 512 from user interface 514, which may include a loss function drop down menu. The loss function drop down menu in interface 514 shows some non-limiting examples of types of loss functions that may be available for the applications described herein (e.g., from top to bottom, “mse,” “A1,” “regularized A1,” “A2,” and “A3”), but the loss functions shown in the drop down menu and the interface may include any suitable loss functions that may vary depending on the application for which the ASMLA is being created.

In another such embodiment, at least two of the multiple loss functions are configured for implementing different methods for regularization in the ASMLA that cannot otherwise be implemented in the ASMLA. For example, the loss functions may implement different methods for regularization techniques that otherwise cannot be implemented in the architecture of the ASMLA. In particular, different loss functions often implement different types of regularization or constraints. In one such example, if the data analysis shows that the number of samples is not sufficient and there is a risk of overfitting, the loss function preferably contains some form of regularization such as L2. Another option is for the selected architecture to contain some form of regularization such as Dropout, LayerNormalization, or others.

In a further such embodiment, at least one of the multiple loss functions is plug in and extendable. For example, the selectable loss functions shown in interface 514 may be loss function plugin architectures. In this manner, the loss function may be implemented in a similar plugin framework so it is extendable.

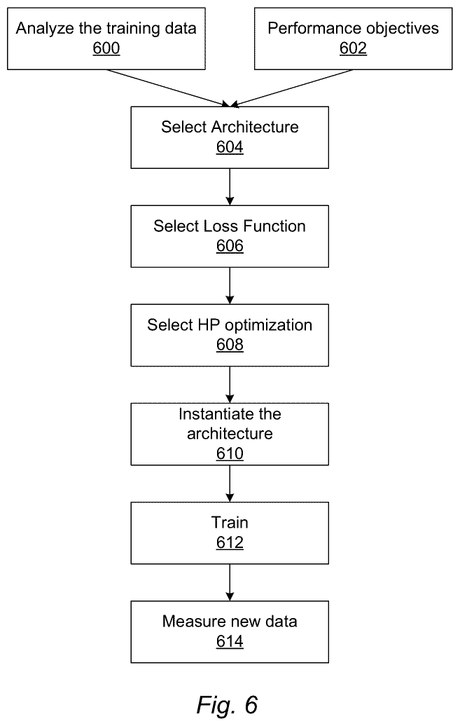

Some embodiments are configured for developing 1) a measurement library that will be used in a process or 2) a recipe for a process using ML. For example, in some embodiments, the application includes performing a process on a specimen, and the one or more computer systems are configured for generating a recipe for the process that includes the selecting step. FIG. 6 shows one embodiment of a method for selecting an architecture. In addition, FIG. 6 shows a procedure to train a library by selecting a modularized architecture block, a plug-in loss function, and a functional HP set.

In one such embodiment, generating the recipe includes collecting data from one or more specimens and reference data for a parameter of the one or more specimens generated by a reference tool and determining the input data metrics for the collected data. For example, the computer system(s) may be configured for collecting data from wafers and reference data about a parameter from a reference tool. This step may be performed using any of the systems shown in FIGS. 1-3. The computer system(s) may also perform analyze the training data step 600, as shown in FIG. 6. This step may include analyzing the data and determining metrics such as number of samples, ranges of parameters, number of references, degrees of freedom (DOF) in the data, etc. The data analysis step may therefore provide information about the number of samples in the training data, the type of data (e.g., design of experiment (DOE) data, nominal data, etc.), labeled or unlabeled data, DOF of the data, precision or tool to tool matching data, etc.

In another embodiment, generating the recipe also includes determining the performance objectives specific to the application. As shown in step 602, the computer system(s) may provide or determine performance objectives. For example, the computer system(s) may be configured for providing performance objectives for the measurement library or recipe such as robustness, tool to tool matching, training time, accuracy, etc. Based on the data analysis and the performance objectives, the computer system(s), a decision algorithm executed by the computer system(s), or a user may select an architecture, as shown in step 604, which may be performed as described further herein.

In an additional embodiment, the selecting step includes selecting a loss function and HPs from the ML library based on the input data metrics and the performance objectives specific to the application. As shown in steps 606 and 608, the computer system(s), a decision algorithm executed by the computer system(s), or a user may select a loss function and HP optimization, respectively, based on the data analysis of step 600, performance objectives 602, and the architecture selected in step 604. For example, the computer system(s) may be configured for selecting an architecture, a loss function, and HPs from a library of architectures and based on the performance objectives and the training data metrics. This selecting step may also be performed as described further herein and based on user input and/or the data analysis and application objectives.

In a further embodiment, the computer system(s) are configured for training and HP optimization with the selected one or more of the multiple architecture templates, the selected loss function, and the selected HPs. For example, the computer system(s) may be configured for training and HP optimization with the selected architecture, loss function, and HPs. HPs are used during the HP optimization. Depending on the number and types of HPs, the space that HP optimization explores could be relatively large and hard to explore or relatively small and more manageable. A relatively small number of HPs is preferable, but may limit the options for finding the best architecture.

When the training and HP optimization time is not an issue, then it is possible to select (or define) a relatively large number of HPs such as number of neurons, regularization, Dropout rate, layer normalization, residual connections, etc. for each layer. This will allow the HP optimization to explore a much larger space of HP and find the model with the best performance. If the training and HP optimization time is relatively limited, the computer system(s) may select HPs that still explore the full space, but with a limited number of HPs. In this case, the HPs may be grouped based on the impact that they have on the performance metrics.

In some embodiments, the selecting step also includes identifying a best ML model after the HP optimization. In other words, the computer system(s) may be configured for selecting the best model after the HP optimization. As shown in step 610, for example, the computer system(s) may instantiate the architecture, which may include creating an instance of the ASMLA with the selected architecture, loss function, and HPs. The instantiated architecture may be the best ML model identified by HP optimization. In this manner, the “best” ML model may be the best version of the selected architecture, loss function, and HPs among those considered during HP optimization. Which of the ML models constitutes the best one may be determined based on any performance metrics of the models and possibly how well the performance metrics meet the performance objectives. The computer system(s) may then train the instantiated architecture in step 612, which may be performed as described further herein.

In still another embodiment, the computer system(s) are configured for collecting a new set of data from a different specimen, determining values of one or more parameters of the different specimen with the best ML model, and monitoring a process performed on the different specimen based on the determined values of the one or more parameters. For example, the computer system(s) may be configured for collecting a new set of data from a new wafer, as shown in step 614, using the best model to determine the values of the parameter, and using the determined values for process monitoring and control. Step 614 may be performed using any of the systems shown in FIGS. 1-3, the output generated by one of those systems may be input to the best model to thereby determine the values of the parameter of the different specimen, and the process monitoring and/or control may be performed in any suitable manner known in the art.

In a further embodiment, the computer system(s) are configured for modifying the best ML model based on the determined values of the one or more parameters or information for the process performed on the specimen. For example, process monitoring and control may require library refresh and retraining by KPI or Quality Metric trigger or task change including functional HP set optimization, and architecture block and template modification. In other words, a Defense metric (KPI) or Quality Metric may be used to judge or trigger ML library refresh. In this manner, once a best model has been released for use, the information determined by the model and/or information about the process being monitored or controlled with the model may be used to update, modify, retrain, etc. the model. In particular, since the architectures described herein are purposely created using plugin and extendable elements, a best architecture that has been released for use may be modified, updated, retrained, etc. in the same manner in which it was created.

The architecture blocks and the architecture templates may have a specific interface that provides information for the size and type of the input data and the format of the output data. They may also provide metadata about the inputs and the outputs so the ASMLA could be constructed to process specific parts of inputs, e.g., the spectra, wavelengths, Mueller elements, subsystems, etc., differently.

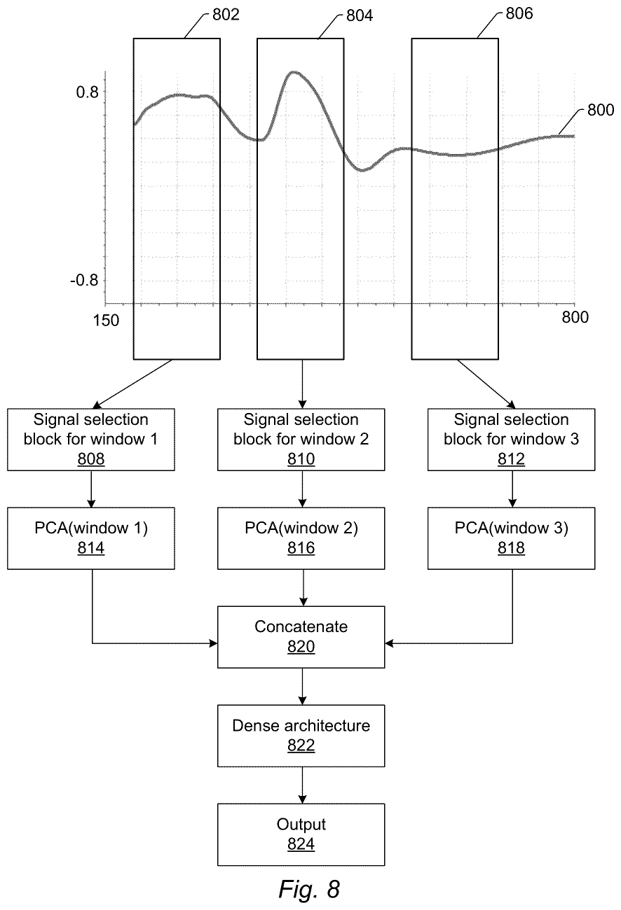

FIG. 8 illustrates a method for processing signal based on wavelengths. This figure shows an example of an architecture that processes different parts of spectra 800 by separate PCA blocks. Sometimes, only particular regions of a spectra may be of interest based on some wavelength certainty. As a non-limiting example shown in FIG. 8, three wavelength windows, namely Window 1 (802), Window 2 (804), and Window 3 (806), are of interest. The architecture allows filtering out signals that fall in one of these three windows and performing PCA on each of these windows separately. For example, the architecture may be configured to allow signal selection block for window 1 (808), signal selection block for window 2 (810), and signal selection block for window 3 (812). The signals selected by each block may then be separately input to separate PCA steps, e.g., PCA (window 1) 814, PCA (window 2) 816, and PCA (window 3) 818. Depending on the sensitivity, each window block can use a different number of significant principal components, concatenate them, and pass them through a dense architecture, which will learn to predict critical parameter(s). For example, the output of each PCA step may be input to concatenate step 820 and then passed through dense architecture 822 to generate output 824, which may include the predicted critical parameter(s) and/or the learned dense architecture.

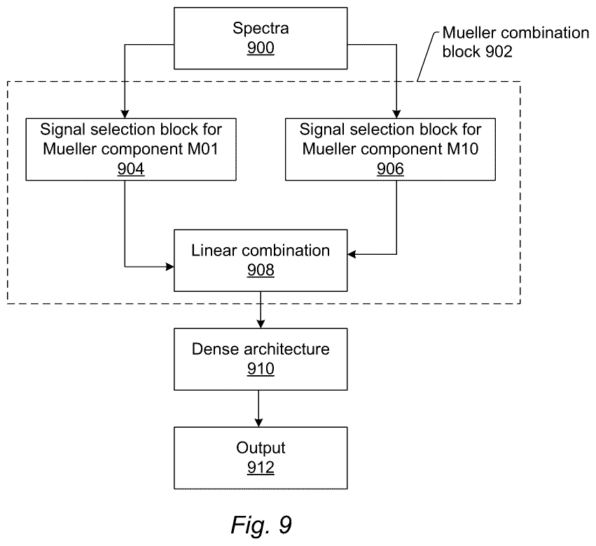

Signals can be extracted not only based on wavelengths but can also be extracted based on Mueller components. In some embodiments, the architecture may process different Mueller elements by performing operations between them extracting asymmetry of the signal for the purpose of measuring overlay. FIG. 9 illustrates one embodiment of processing signals based on Mueller components to measure overlay. For example, in FIG. 9, two Mueller components “M01” and “M10” are extracted from spectra 900 using the signal selection blocks, 904 and 906, respectively, and these signals undergo some linear combination 908. The signal selection along with the linear operation among the two signals, can be considered a Mueller combination block 902. These kinds of blocks are used to extract asymmetries from signals for a particular structure to measure overlay. The output of the linear combination step may be passed through dense architecture 910, which may generate output 912.

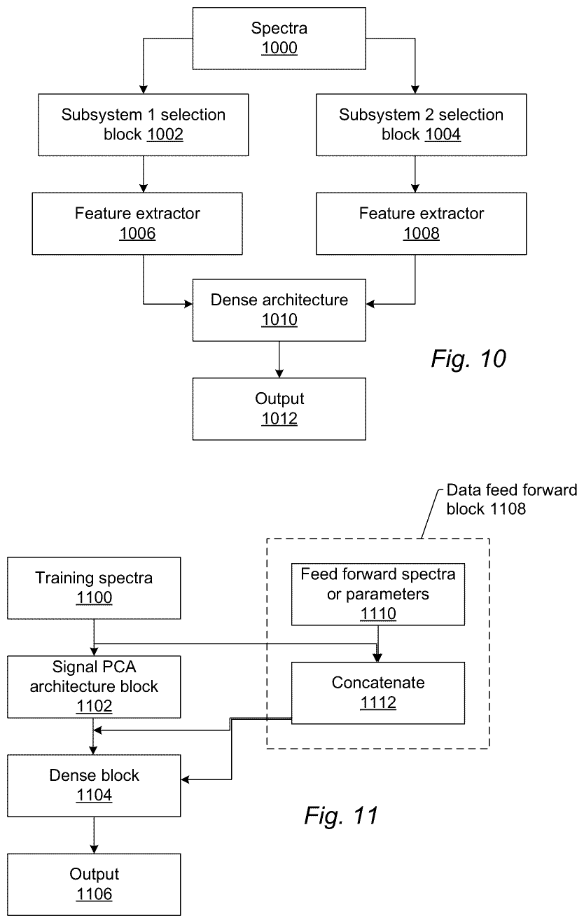

In another embodiment, the architecture may process different subsystems (or modes) individually. Each of the different subsystems (or modes) may be configured as shown in FIGS. 1-3. For example, FIG. 10 illustrates one embodiment of processing signals based on subsystems. In FIG. 10, signals are extracted from spectra 1000 by subsystem 1 selection block 1002 and subsystem 2 selection block 1004 based on subsystems with which they are measured. By processing these subsystem-specific signals, feature extraction can be performed on them individually by feature extractors 1006 and 1008, respectively, followed by combining the outputs of the individual feature extractors and passing them to a ML or NN layer or architecture such as dense architecture 1010 to predict critical parameters (output 1012).

In some embodiments, the application is a metrology process performed on a specimen. In another embodiment, the application is an inspection process performed on a specimen. For example, the embodiments described herein may be particularly suitable for creating an ASMLA using the constructed ML library for semiconductor quality control type processes such as inspection, metrology, and defect review, each of which may be performed as described further herein using one or more of the systems shown in FIGS. 1-3. The embodiments are also not limited in the types of such processes, tools and specimens for which they may create as ASMLA. For example, the embodiments described herein are particularly advantageous in that they can easily be used to quickly generate a new architecture for an application based on an arbitrary set of blocks, templates, loss functions, HPs and their associated metadata stored in an ML library constructed as described herein.

The embodiments described herein may include or use layer-specific and/or application-specific architecture templates. In addition, in some embodiments, the ML library is specific to a first layer, a first application, a first user, or first input data metrics, and the computer system(s) are configured for constructing an additional ML library specific to a second layer, a second application, a second user, or second input data metrics, respectively, and constructing a ML gallery including the ML library and the additional ML library. In this manner, the selected architecture template may include multiple architecture blocks and/or templates that are extendable layer and/or application specific, or user-custom from stored galleries of architecture template libraries.

Architecture template galleries may include a relatively large number of proven architecture template libraries that fit to specific layer(s) and/or specific application(s) or specific data availability conditions(s). Each specific library template may include one or multiple architecture blocks connected by multiple operations such as seeding, concatenation, residual, adding, and filtering. A layer specific architecture template is proven to cover specific layer problems. For wider usage, application architecture templates could be developed and easily plugged in and extendable given any recipe development or recipe retraining. FIGS. 11-14 depict various architecture templates to cover different applications. Stored layer and/or application specific architecture templates could advantageously reduce recipe training time significantly.

FIG. 11 illustrates an embodiment of a data feed forward architecture template. Such a data feed forward configuration may be used for a highly correlated parameters application. For example, when certain shape parameter sets are highly correlated such as common underlayer structure parameters in a previous step layer or the structure includes many highly correlated parameters, parameter data feed forward may break down the correlation among those parameters and improve robustness by feeding additional information into recipe training as shown in FIG. 11. Data feed forward may be modularized as an architecture block 1108 and can be easily plugged in any intermediate stage (feed forward in raw input, after PCA, or in any intermediate dense layer). Similarly, spectra in pre-steps could be fed forward in this manner. For example, training spectra 1100 and feed forward spectra or parameters 1110 from data feed forward block 1108 may be input to concatenate step 1112 in block 1108. The training spectra may also be input to signal PCA architecture block 1102. The results generated by concatenate step 1112 and signal PCA architecture block 1102 may be input together or separately into dense block 1104, which may generate output 1106.

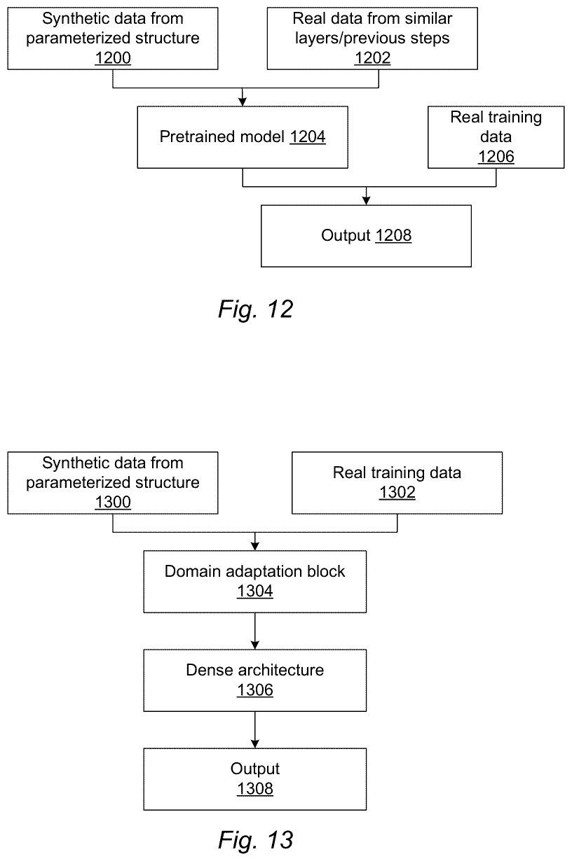

Some embodiments for situations that lack data application specific templates include transfer learning using a pretrained model as shown in FIG. 12 and domain adaptation as shown in FIG. 13. For example, when the availability of number of real wafers is relatively low, synthetically generated data from a well-defined parameterized structure can be used in different ways including constructing a pretrained model or domain adaptation from real to synthetic. Mass lot data or synthetic data already collected in pre-step or similar layers can be used to train the model that can be reused as a pretrained model. In another way, synthetic data can be used for domain adaptation.

As shown in FIG. 12, for example, synthetic data from a parameterized structure 1200 and real data from similar layers and/or previous steps 1202 may be input to pretrained model 1204. The results generated by the pretrained model and real training data 1206, which may be relatively lacking as described above, may then be used to generate output 1208.

As shown in FIG. 13, synthetic data from a parameterized structure 1300 and real training data 1302 may be input to domain adaptation block 1304. The output of the domain adaptation block may be passed through dense architecture 1306 to thereby generate output 1308.

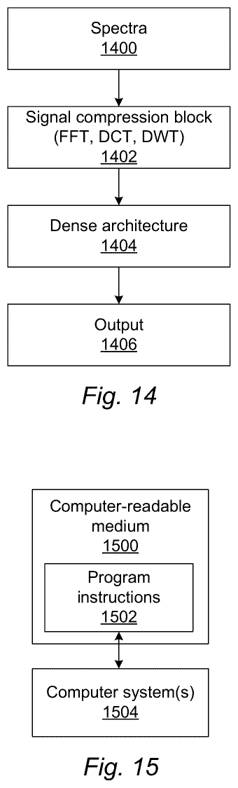

FIG. 14 illustrates an embodiment of a high aspect ratio structure application template. This embodiment may be used for a high aspect ratio structure with an oscillating spectra. This embodiment may include inputting spectra 1400 into signal compression block 1402 to transform the spectra to the frequency domain. For example, to resolve the challenge of high aspect ratio 3D NAND metrology with oscillating spectra, signals can be compressed and transformed in frequency domain using discrete cosine transform (DCT), discrete wavelet transform (DWT), Fast Fourier Transform (FFT), etc. The output of the signal compression block may be passed through dense architecture 1404 to thereby generate output 1406.

In some embodiments, the computer system(s) are configured for storing information for at least the ML library, but also possibly any other results generated as described herein such as a ASMLA, a trained model, etc. In the case of the ML library, the computer system(s) may be configured to store the library so that it can be used to generate a recipe, which may include a library used by the recipe or one or more steps performed with the recipe. In the case of an ASMLA or a trained model, the computer system(s) may be configured to store any of such information in a recipe or by generating a recipe for the process in which the ASMLA or trained model will be used. A “recipe” as that term is used herein can be generally defined as a set of instructions that can be used by a tool to perform a process. In this manner, generating a recipe may include generating information for how a process is to be performed, which can then be used to generate the instructions for performing that process. The information that is stored by the computer system(s) may include any information that can be generated by the computer system(s) as described further herein.

The computer system(s) may be configured for storing the information in any suitable computer-readable storage medium. The information may be stored in any manner known in the art. The storage medium may include any storage medium described herein or any other suitable storage medium known in the art. After the information has been stored, the information can be accessed in the storage medium and used by any of the method or system embodiments described herein, formatted for display to a user, used by another software module, method, or system, etc. For example, the embodiments described herein may generate a recipe as described above. That recipe may then be stored and used by the system or method (or another system or method) to perform a process.

The computer system(s) may also be configured for generating results that include information for the specimen, which may include any of the results or information described herein. For example, as described further above, the computer system(s) may be included in a system that determines information for the specimen by inputting the runtime specimen images, data, signals, etc. into the trained ASMLA or model. The results generated in this manner may be output by the computer system(s) in any suitable manner. All of the embodiments described herein may be configured for storing results of one or more steps of the embodiments in a computer-readable storage medium. The results may include any of the results described herein and may be stored in any manner known in the art. The results may have any suitable form or format such as a standard file type. The storage medium may include any storage medium described herein or any other suitable storage medium known in the art.

After the results have been stored, the results can be accessed in the storage medium and used by any of the method or system embodiments described herein, formatted for display to a user, used by another software module, method, or system, etc. to perform one or more functions for the specimen or another specimen of the same type. Such results produced by the computer system(s) may include information for any defects detected on the specimen such as location, etc., of the bounding boxes of the detected defects, detection scores, information about defect classifications such as class labels or IDs, any defect attributes determined from any of the images, etc., specimen structure measurements, dimensions, shapes, etc. or any such suitable information known in the art. That information may be used by the computer system(s) or another system or method for performing additional functions for the specimen and/or the detected defects such as sampling the defects for defect analysis, determining a root cause of the defects, etc.

Such functions also include, but are not limited to, altering a process such as a fabrication process or step that was or will be performed on the specimen in a feedback or feedforward manner, etc. For example, the computer system(s) may be configured to determine one or more changes to a process that was performed on the specimen and/or a process that will be performed on the specimen based on the information determined for the specimen. The changes to the process may include any suitable changes to one or more parameters of the process. In one such example, the computer system(s) preferably determine those changes such that the defects can be reduced or prevented on other specimens on which the revised process is performed, the defects can be corrected or eliminated on the specimen in another process performed on the specimen, the defects can be compensated for in another process performed on the specimen, etc. The computer system(s) may determine such changes in any suitable manner known in the art.

Those changes can then be sent to a semiconductor fabrication system (not shown) or a storage medium (not shown) accessible to both the computer system(s) and the semiconductor fabrication system. The semiconductor fabrication system may or may not be part of the system embodiments described herein. For example, the systems described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a CMP tool, a deposition tool, and the like.

The embodiments described herein have a number of advantages in addition to those already described. For example, the embodiments described herein provide a library of layer/application specific ML architectures. In addition, the embodiments provide the ability to modify existing or add new architectures, loss functions, pre-processing steps, etc. The embodiments described herein are also advantageous in the implementation of architecture blocks, which are easy to use (e.g., by non-advanced applications engineers) blocks to construct arbitrary architectures. The embodiments described herein further provide a reduced number of easy-to-understand HPs (e.g., capacity, regularization, depth, etc.). Furthermore, the embodiments provide arbitrary and application specific HPs. The embodiments also may include or use HPs that can explore families of architectures. In addition, functional HPs with a similar role have a stronger relationship to the performance metric. This enables users to interpret results easily and therefore to optimize the model given less HP search (time to solution improvement) or to the tune the library quickly.

Each of the embodiments of each of the systems described above may be combined together into one single embodiment.

Another embodiment relates to a computer-implemented method for constructing a ML library. The method includes defining multiple architecture blocks, each of which is a reusable piece of ML architecture. The method also includes defining multiple architecture templates, each of which is a reusable template configurable for including one or more of the multiple architecture blocks. In addition, the method includes assigning metadata to the multiple architecture templates responsive to input data metrics and performance objectives for which the multiple architecture templates are suited. The method further includes storing the multiple architecture blocks, the multiple architecture templates, and the metadata in a ML library configured for use in selecting one or more of the multiple architecture templates for an ASMLA based on the input data metrics and the performance objectives specific to the application. The steps are performed by one or more computer systems.

Each of the steps of the method may be performed as described further herein. The method may also include any other step(s) that can be performed by the system, output acquisition subsystem, models, computer systems, etc. described herein. The system, output acquisition subsystem, models, computer system(s), etc. may be configured according to any of the embodiments described herein. The method may be performed by any of the system embodiments described herein.

An additional embodiment relates to a non-transitory computer-readable medium storing program instructions executable on a computer system for performing a computer-implemented method for constructing a ML library. One such embodiment is shown in FIG. 15. In particular, as shown in FIG. 15, non-transitory computer-readable medium 1500 includes program instructions 1502 executable on computer system(s) 1504. The computer-implemented method includes the steps of the methods described herein.

Program instructions 1502 implementing methods such as those described herein may be stored on computer-readable medium 1500. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system(s) 1504 may be configured according to any of the embodiments described herein.

Further modifications and alternative embodiments of various aspects of the invention will be apparent to those skilled in the art in view of this description. For example, methods and systems for constructing a ML library are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for constructing a machine learning library, comprising:
one or more computer systems configured for:
defining multiple architecture blocks, wherein each of the multiple architecture blocks is a reusable piece of machine learning architecture;
defining multiple architecture templates, wherein each of the multiple architecture templates is a reusable template configurable for including one or more of the multiple architecture blocks;
assigning metadata to the multiple architecture templates responsive to input data metrics and performance objectives for which the multiple architecture templates are suited; and
storing the multiple architecture blocks, the multiple architecture templates, and the metadata in a machine learning library configured for use in selecting one or more of the multiple architecture templates for an application-specific machine learning architecture based on the input data metrics and the performance objectives specific to the application.

2. The system of claim 1, wherein the one or more computer systems are further configured for performing said selecting.

3. The system of claim 1, wherein the multiple architecture templates comprise at least one architecture template that is layer-specific, application-specific, or user-customized, and wherein one or more characteristics of the at least one architecture template are modifiable to a different layer or application.

4. The system of claim 1, wherein the multiple architecture blocks comprise at least one architecture block that is layer-specific, application-specific, or user-customized, and wherein one or more characteristics of the at least one architecture block are modifiable to a different layer or application during said selecting.

5. The system of claim 1, wherein the machine learning library is specific to a first layer, a first application, a first user, or first input data metrics, and wherein the one or more computer systems are further configured for constructing an additional machine learning library specific to a second layer, a second application, a second user, or second input data metrics, respectively, and constructing a machine learning gallery comprising the machine learning library and the additional machine learning library.

6. The system of claim 1, wherein the one or more computer systems are further configured for defining hyperparameters for the multiple architecture templates, assigning additional metadata to the hyperparameters responsive to the input data metrics and the performance objectives for which the hyperparameters are suited, and storing the hyperparameters and the additional metadata in the machine learning library further configured for use in selecting one or more of the hyperparameters for the application-specific machine learning architecture based on the input data metrics and the performance objectives specific to the application.

7. The system of claim 6, wherein the one or more computer systems are further configured for selecting the one or more of the multiple architecture templates and the one or more of the hyperparameters for the application-specific machine learning architecture based on the input data metrics and the performance objectives specific to the application.

8. The system of claim 6, wherein the hyperparameters comprise functional hyperparameters, and wherein each of the functional hyperparameters are a function of two or more of the hyperparameters with a similar role.

9. The system of claim 6, wherein at least one of the hyperparameters is configured for selecting the one or more of the multiple architecture templates for the application-specific machine learning architecture based on the input data metrics and the performance objectives specific to the application.

10. The system of claim 6, wherein at least one of the hyperparameters is configured for controlling one or more characteristics and one or more capabilities of the application-specific machine learning architecture.

11. The system of claim 10, wherein the at least one of the hyperparameters comprises a capacity hyperparameter configured for controlling total capacity of the application-specific machine learning architecture by changing one or more properties of the application-specific machine learning architecture.

12. The system of claim 10, wherein the at least one of the hyperparameters comprises a regularization hyperparameter configured for controlling regularization of the application-specific machine learning architecture by changing one or more properties of the application-specific machine learning architecture.

13. The system of claim 10, wherein the at least one of the hyperparameters comprises an aspect ratio hyperparameter configured for controlling depth and width of layers of the application-specific machine learning architecture and total number of parameters of the layers.

14. The system of claim 1, wherein the one or more computer systems are further configured for defining multiple loss functions, assigning additional metadata to the multiple loss functions responsive to the input data metrics and the performance objectives for which the multiple loss functions are suited, and storing the multiple loss functions and the additional metadata in the machine learning library further configured for use in selecting one or more of the multiple loss functions for the application-specific machine learning architecture based on the input data metrics and the performance objectives specific to the application.

15. The system of claim 14, wherein the one or more computer systems are further configured for selecting the one or more of the multiple architecture templates and the one or more of the multiple loss functions for the application-specific machine learning architecture based on the input data metrics and the performance objectives specific to the application.

16. The system of claim 14, wherein at least two of the multiple loss functions are configured for implementing different methods for regularization in the application-specific machine learning architecture that cannot otherwise be implemented in the application-specific machine learning architecture.

17. The system of claim 14, wherein at least one of the multiple loss functions is plug in and extendable.

18. The system of claim 1, wherein the application comprises performing a process on a specimen, and wherein the one or more computer systems are further configured for generating a recipe for the process comprising said selecting.

19. The system of claim 18, wherein said generating further comprises collecting data from one or more specimens and reference data for a parameter of the one or more specimens generated by a reference tool and determining the input data metrics for the collected data.

20. The system of claim 19, wherein said generating further comprises determining the performance objectives specific to the application.

21. The system of claim 20, wherein said selecting comprises selecting a loss function and hyperparameters from the machine learning library based on the input data metrics and the performance objectives specific to the application.

22. The system of claim 21, wherein the one or more computer systems are further configured for training and hyperparameter optimization with the selected one or more of the multiple architecture templates, the selected loss function, and the selected hyperparameters.

23. The system of claim 22, wherein said selecting further comprises identifying a best machine learning model after the hyperparameter optimization.

24. The system of claim 23, wherein the one or more computer systems are further configured for collecting a new set of data from a different specimen, determining values of one or more parameters of the different specimen with the best machine learning model, and monitoring a process performed on the different specimen based on the determined values of the one or more parameters.

25. The system of claim 24, wherein the one or more computer systems are further configured for modifying the best machine learning model based on the determined values of the one or more parameters or information for the process performed on the specimen.

26. The system of claim 1, wherein the application is a metrology process performed on a specimen.

27. The system of claim 1, wherein the application is an inspection process performed on a specimen.

28. A non-transitory computer-readable medium, storing program instructions executable on a computer system for performing a computer-implemented method for constructing a machine learning library, wherein the computer-implemented method comprises:
defining multiple architecture blocks, wherein each of the multiple architecture blocks is a reusable piece of machine learning architecture;
defining multiple architecture templates, wherein each of the multiple architecture templates is a reusable template configurable for including one or more of the multiple architecture blocks;
assigning metadata to the multiple architecture templates responsive to input data metrics and performance objectives for which the multiple architecture templates are suited; and
storing the multiple architecture blocks, the multiple architecture templates, and the metadata in a machine learning library configured for use in selecting one or more of the multiple architecture templates for an application-specific machine learning architecture based on the input data metrics and the performance objectives specific to the application.

29. A computer-implemented method for constructing a machine learning library, comprising:
defining multiple architecture blocks, wherein each of the multiple architecture blocks is a reusable piece of machine learning architecture;
defining multiple architecture templates, wherein each of the multiple architecture templates is a reusable template configurable for including one or more of the multiple architecture blocks;
assigning metadata to the multiple architecture templates responsive to input data metrics and performance objectives for which the multiple architecture templates are suited; and
storing the multiple architecture blocks, the multiple architecture templates, and the metadata in a machine learning library configured for use in selecting one or more of the multiple architecture templates for an application-specific machine learning architecture based on the input data metrics and the performance objectives specific to the application, wherein defining the multiple architecture blocks, defining the multiple architecture templates, said assigning, and said storing are performed by one or more computer systems.
